(19) United States
(12) Patent Application Publication
(10) Pub. No.: US 2022/0135475 A1
(43) Pub. Date: May 5, 2022

(54) METHOD FOR INCREASING THE STRENGTH OF A GLASS SUBSTRATE

(71) Applicant: FRAUNHOFER-GESELLSCHAFT ZUR FÖRDERUNG DER ANGEWANDTEN FORSCHUNG E.V., München (DE)

(72) Inventors: Manuela A. JUNGHÄHNEL, Dresden (DE); Jasper WESTPHALEN, Dresden (DE); Thomas PREUSSNER, Dresden (DE); Wiebke Langgemach, Dresden (DE)

(73) Assignee: FRAUNHOFER-GESELLSCHAFT ZUR FÖRDERUNG DER ANGEWANDTEN FORSCHUNG E.V., München (DE)

(21) Appl. No.: 17/431,081

(22) PCT Filed: Feb. 13, 2020
(86) PCT No.: PCT/EP2020/053725

§ 371 Date: Aug. 13, 2021

(30) Foreign Application Priority Data
Feb. 16, 2019 (DE) 10 2019 103 947.9
Dec. 17, 2019 (DE) 10 2019 134 818.8

(51) Int. Cl. C03C 23/00

(52) U.S. Cl. CPC C03C 23/0025

(57) ABSTRACT

Methods for increasing the strength of a planar or strip-shaped glass substrate are provided. Electromagnetic radiation in the wavelength range from 180 nm to 1100 nm is applied to the glass substrate by means of at least one pulse, wherein the at least one pulse has a radiation bandwidth of at least 100 nm and the glass substrate has a temperature of at most 200° C. prior to the at least one pulse acting thereon, and wherein the pulse energy density of the at least one pulse of electromagnetic radiation is set in the range from 0.1 Jcm-2 to 100 Jcm-2.

### CROSS-REFERENCE TO RELATED APPLICATIONS

This application is a 371 nationalization of international patent application PCT/EP2020/053725 filed Feb. 13, 2020, which claims priority under 35 USC § 119 to German patent application DE 10 2019 103 947.9 filed Feb. 16, 2019 and German patent application DE 10 2019 134 818.8 filed Dec. 17, 2019. The entire contents of each of the above-identified applications are hereby incorporated by reference.

### BRIEF DESCRIPTION OF THE DRAWINGS

The figures show the following:

FIG. 1 a schematic illustration of a device for carrying out steps of the procedure according to the invention; and

FIG. 2 a schematic illustration of an alternative device for carrying out steps of the procedure according to the invention.

### DETAILED DESCRIPTION

The invention relates to a method for increasing the strength of glass substrates, which are, in particular, plate-shaped or ribbon-shaped.

For example, in the construction industry, automotive engineering and photovoltaic applications, high-strength glass substrates are required to enable the longevity of corresponding products.

The strength of glass objects, for example, glass panes or glass bottles, is largely determined through the surface quality. The fewer defects, such as micro-cracks or scratches, are found on the glass surface, the higher the achievable strength of the glass object.

There are various ways to refine the surface of glass objects and thus reduce the defect density or increase the strength of the glass objects. For example, chemical, diffusion-driven exchange processes are known, in which glass objects are immersed in a salt melt and sodium ions from the glass surface are exchanged for potassium ions. By installing the larger potassium ions instead of the sodium ions, compressive stresses are generated within the surface layer, which increase the strength of the glass. With this procedure, strengths of glasses in the range of 500 MPa can be achieved. The disadvantage here is that the diffusion-driven exchange processes take a very long time and require process times of up to 24 hours. In addition, the cleaning and recovery of the salt melt used here is very time and cost intensive.

EP 2 319 814 A1 proposes submerging a glass product into a salt melt at a temperature above its upper cooling temperature in order to perform an ion exchange. In this way, the exchange process can be shortened in terms of time. However, the disadvantage of this approach is the intensive processing of the salt melt used, both in terms of time and costs.

In addition, thermal processes for prestressing glasses (DE 2 049 719 A) are also known, in which a glass substrate is heated to a temperature above its transformation temperature and then quenched abruptly. The glass network on the surface of the glass is frozen in the expanded state, while the core of the glass can contract. Due to the different expansion coefficients of the surface and core, compressive stresses are generated in the glass surface, which have a strength-increasing effect. The glass substrate can be quenched through gaseous, liquid or solid media. The disadvantage of this procedure is, for example, that the achievable strength is lower than in chemical prestressing. This procedure results in uncontrolled and random nickel sulfide germs, which can later lead to spontaneous breakage of a glass as a result of recrystallization. The thinner a glass substrate is formed, the higher temperature gradients and cooling speeds can be generated, which is why these procedures are not suitable for glass thicknesses below 3 mm.

The strength of glass substrates can furthermore be improved through mechanical polishing of the glass surface, as shown for example in DE 10 2010 033 041 A1. It is also known to heat a glass substrate by means of a burner flame in order to evaporate highly volatile components from the glass substrate (EP 2 204 354 A2) and at the same time heal microcracks in the glass, which can increase the strength of the glass. One disadvantage of this method is that the evaporated components of the glass settle in cooler areas near the heated zones of the glass object. The direct contact of the glass with the flame can also cause local overheating. In addition, extensive burner and cooling technology is required for the extensive treatment of glass. Large amounts of exhaust gas are formed during the treatment of large-area glass substrates, which can be discharged from a process room and cleaned.

Therefore, the invention is based on the technical problem of creating a method for increasing the strength of glass substrates, by means of which the disadvantages from the prior art can be overcome. In particular, it should also be possible with the procedure according to the invention to increase the strength of thin-walled glass substrates with a thickness of less than 3 mm.

Surprisingly, the strength of a plate or ribbon-shaped glass substrate can be increased if the glass substrate is subjected to light flashes. In the procedure according to the invention for increasing the strength of a plate or ribbon-shaped glass substrate, the glass substrate is therefore applied with at least one pulse of an electromagnetic radiation in the wavelength range from 180 nm to 1100 nm.

The flash's effect on the glass substrate causes a local temperature increase in the surface areas of the glass substrate. In the process, highly volatile components emerge from the glass substrate and microcracks in the glass substrate are presumably also healed, which could justify the increase in strength.

With the procedure according to the invention, it was possible to increase the strength of plate and ribbon-shaped glass substrates, based on a bending stress, by more than 50%. For example, silicate glasses containing alkali or borosilicate glasses can be used as glass substrate for the procedure according to the invention.

The method according to the invention is particularly suitable for large-surface, plate and ribbon-shaped glass substrates with low substrate thickness. In order to enable a required energy input into a glass substrate, particularly, with thin glasses, flash pulses with a radiation range of at least 100 nm are suitable for the procedure according to the invention. Glass substrates with a substrate thickness of less than 3 mm can also be treated here. In one embodiment, a glass substrate with a maximum thickness of 24 mm is used.

The electromagnetic radiation required for the procedure according to the invention can be generated by means of a gas discharging lamp, for example. For example, the Xenon flash lamps are suitable for this purpose. A xenon flash lamp usually generates an electromagnetic radiation in the wavelength range of about 180 nm to 1100 nm and its flash pulses thus have a radiation range of about 920 nm. Therefore, Xenon flash lamps are also particularly suitable for the hardness according to the invention of glasses with a glass thickness of less than 3 mm.

The impingement of a plate or ribbon-shaped glass substrate with at least one flash pulse can be carried out both as a static process and as a dynamic process, in which the light flash generating device and the glass substrate to be treated have a relative speed to one another.

The procedure according to the invention can be integrated into the production process of glass substrates with relatively little effort and can, for example, follow directly after glass production. The environmental conditions can also be designed differently in the procedure according to the invention. For example, it is possible to carry out the procedure according to the invention under atmospheric conditions, in a vacuum or in the presence of a protective gas. If the procedure according to the invention is carried out within a vacuum chamber, the pumps can be used simultaneously to maintain the vacuum in the vacuum chamber in order to pump the volatile components from the glass substrates out of the vacuum chamber. When performing the procedure according to the invention, in which a glass substrate to be treated is located within a vacuum chamber, it is also advantageous that the device generating at least one flash pulse can be arranged either inside or outside the vacuum chamber. The device generating the flash pulse can thus be, for example, arranged outside the vacuum chamber in front of a window within a vacuum chamber wall and the glass substrate can be applied with the at least one lightning pulse within the vacuum chamber through the window.

In a plurality of applications, it is sufficient if the glass substrate has a temperature corresponding to the room temperature before the effect of at least one flash pulse. However, a glass substrate can also be heated to a maximum temperature of 200° C. prior to the effect of the at least one flash pulse, whereby the amount of energy to be entered into the glass substrate with the at least one flash pulse can be reduced.

In one embodiment of the invention, the duration of at least one flash pulse is set to the range of 0.2 ms to 100 ms.

An essential parameter for the method according to the invention is the pulse energy density of at least one flash pulse. If the pulse energy density is selected too low, it does not increase the strength of a glass substrate. If the pulse energy density is too high, the glass substrate may melt, which reduces the strength of the glass substrate or may also destroy the glass substrate in extreme cases. In the procedure of the invention the pulse energy density of at least one flash pulse is therefore set to the range from 0.1 Jcm⁻² to 100 Jcm⁻². Particularly good results when increasing the strength of glass substrates could be achieved when the pulse energy density of at least one flash pulse was set to a range from 1 Jcm⁻² to 50 Jcm⁻².

In another embodiment of the invention, a reflector for the electromagnetic radiation is arranged behind the glass substrate and/or behind the device for generating the at least one flash pulse of the electromagnetic radiation.

The present invention is explained in more detail below using design examples. The figures show the following:

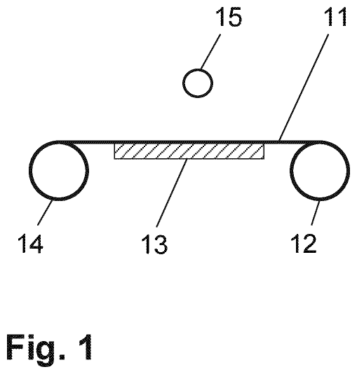

The strength of a ribbon-shaped glass substrate 11 can be increased by means of a device shown in FIG. 1. For this purpose, the ribbon-shaped glass substrate 11 is unwound from a first roll 12 under atmospheric conditions, guided via a substrate carrier 13 and wound onto a second roll 14. While the ribbon-shaped glass substrate is guided via the substrate carrier 13, the ribbon-shaped glass substrate 11 is subjected to electromagnetic radiation from a gas discharge lamp 15 configured as a Xenon flash lamp. The feed rate of the ribbon-shaped glass substrate 11 and the flash duration of the gas discharge lamp 15 are coordinated in the described exemplary embodiment such that each surface region of the ribbon-shaped glass substrate 11 is substantially subjected to the electromagnetic radiation of only one flash of the gas discharge lamp 15. Alternatively, the feed rate of the ribbon-shaped glass substrate 11 and the flash duration of the gas discharge lamp 15 can be coordinated with each other in such a way that each surface region of the ribbon-shaped Glass substrate 11 is applied to the electromagnetic radiation of several flashes from the gas discharge lamp 15. Applying light flashes to the ribbon-shaped glass substrate 11 leads to a local temperature increase in the surface areas of the glass substrate, whereby volatile components are expelled from the glass substrate and microcracks are presumably also healed, which leads to an increase in the strength of the ribbon-shaped glass substrate.

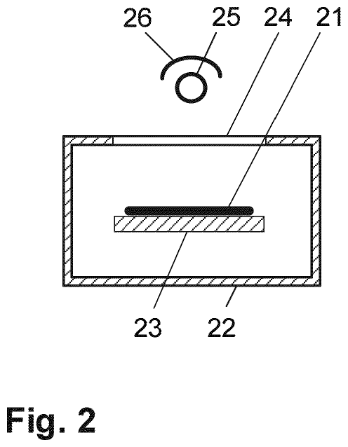

FIG. 2 schematically shows an alternative device, by means of which the strength of plate-shaped glass substrates 21 is to be increased from an alkali-earth-alkaline-silicate glass with a glass thickness of 3 mm. A glass substrate 21 is located within a vacuum chamber 22 on a substrate carrier 23. A gas discharge lamp 25 embodied as a Xenon flash lamp is arranged in front of a quartz glass window 24 inside a wall of the vacuum chamber 22. The gas discharge lamp 25 generates pulses of electromagnetic radiation, which penetrates the quartz glass window 24 and then impinges on the glass substrate 21. In the exemplary embodiment described in FIG. 2, each glass substrate 21 is only applied with the electromagnetic radiation of a flash pulse of the gas discharge lamp 25. Alternatively, a glass substrate 21 can also be applied with several flash pulses of the gas discharge lamp 25, wherein various adjacent or overlapping surface regions of a glass substrate 21 can be applied with one or more flash pulses of the gas discharge lamp 25.

Thus, in another alternative embodiment, only a partial area of the surface of the glass substrate 21 is initially subjected to one or more flash pulses of the gas discharge lamp 25 and then a change of position of the glass substrate 21 and/or the gas discharge lamp 25 is carried out, according to which a different partial area of the surface of the glass substrate 21 is subjected to one or more flash pulses of the gas discharge lamp 25.

The device according to FIG. 2 further comprises a reflector 26, which is arranged behind the gas discharge lamp 25 in relation to the glass substrate 21 and which increases the proportion of electromagnetic radiation generated by the gas discharge lamp 25 and emitted in the direction of the glass substrate 21.

Depending on the type and thickness of a used glass substrate 21, it can be sufficient if only one side of the glass substrate 21 is applied with electromagnetic radiation of the gas discharge lamp 25 in order to achieve a desired strength increase. However, it is also possible to first apply at least one flash pulse to one side of the glass substrate 21 and then other side of the glass substrate 21. Furthermore, the substrate carrier 23 can also be configured as a reflector for the electromagnetic radiation generated by the gas discharge lamp 25 in order to extend the beam path of the electromagnetic radiation within the glass substrate and thus increase the effect.

With the test arrangement shown in FIG. 2, a plurality of glass substrates 21 were irradiated with a lightning pulse of the gas discharge lamp 25 with a different pulse energy density. However, at least 30 glass substrates were always subjected to the same pulse energy density, then subjected to a strength test and a mean value for the strength of the glass substrate 21 of a batch was determined for each pulse energy density value. The strength test of substrates 21 was carried out with a double ring bending test according to DIN EN 1288-5: 2000-09. The results of the test series are listed in the following table, whereby in the first column the pulse energy density value of the flash pulse radiated by the gas discharge lamp 25 for a respective glass substrate 21 in J/cm² and in the second column the mean value determined for the corresponding batch of glass substrates 21 for their strength in MPa are given.

| Pulse energy density in J/cm² | Mean strength value in MPa |
|---|---|
| 0 | 276.4 |
| 3.7 | 419.5 |
| 7.5 | 406.0 |
| 11.2 | 433.2 |
| 18.9 | 363.2 |

It can be seen from the table that the glass substrates 21 treated with the procedure according to the invention have at least 30% greater strength than that of untreated glass substrates 21.

It should be mentioned at this point that the glass types, glass thicknesses and operating parameters named in the exemplary embodiments are only shown as examples and that they do not limit the scope of the invention.

To clarify the use of and to hereby provide notice to the public, the phrases “at least one of <A>, <B>, . . . and <N>” or “at least one of <A>, <B>, . . . or <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. A method for increasing the strength of a plate-shaped or ribbon-shaped glass substrate, the method comprising: exposing the glass substrate to at least one pulse of an electromagnetic radiation in a wavelength range from 180 nm to 1100 nm, wherein at least one pulse has a radiation bandwidth of at least 100 nm and the glass substrate has a maximum temperature of 200° C. before the glass substrate is exposed to the at least one pulse, and wherein the pulse energy density of the at least one pulse of the electromagnetic radiation is set in a range of 0.1 Jcm⁻² to 100 Jcm⁻².

2. The method of claim 1, wherein the glass substrate includes an alkali-containing silicate glass or a borosilicate glass.

3. The method of claim 1, wherein the glass substrate has a maximum thickness of 24 mm.

4. The method of claim 1, wherein the electromagnetic radiation is generated by a gas discharging lamp.

5. The method of claim 4, wherein the electromagnetic radiation is generated by a Xenon flash lamp.

6. The method of claim 1, wherein the electromagnetic radiation is generated by of a laser device.

7. The method of claim 1, wherein the duration of at least one pulse of the electromagnetic radiation is set in a range from 0.2 ms to 100 ms.

8. The method of claim 1 further comprises arranging a reflector for the electromagnetic radiation behind the glass substrate and/or behind a device that generates the at least one pulse of the electromagnetic radiation.
